(19) United States
(12) Patent Application Publication
(10) Pub. No.: US 2005/0146483 A1
(43) Pub. Date: Jul. 7, 2005

(54) Satellite dish antenna support system

(76) Inventor: Gerard Levasseur, Nashua, NH (US)

Correspondence Address: Lambert & Associates, 92 State Street, Boston, MA, 02109-2004, US

(21) Appl. No.: 10/751,139

(22) Filed: Jan. 5, 2004

(51) Int. Cl. H01Q 1/12

(52) U.S. Cl. 343/878

(57) ABSTRACT

A vehicle-mounted satellite dish antenna support system that may be fixed at varying heights and a variety of radial positions to maximize signal reception while retaining the mobility of automobile travel. The satellite dish antenna support system includes telescopically related members designed to facilitate desired positioning in both the vertical and angular planes.

### FIELD OF THE INVENTION

This invention relates generally to the field of communication support systems and specifically to a support system for a satellite dish antenna that may be attached to the trailer hitch receiver portion of an automobile.

### BACKGROUND OF THE INVENTION

Supports and mounting assemblies for television satellite dish antennae have traditionally been designed for household use. Generally, these dish antennae are affixed to the roof, chimney, porch, outside railings, or other portions of a building or structure. However, modern television viewing is no longer confined to the home as many automobiles, including sports utility vehicles, are becoming available with television viewing equipment as part of a standard accessory package. Unfortunately, the reception quality of these automobile television systems is quite poor. Frustrated with the lack of viewing options, users must often resort to only viewing images that are of the closed-circuit variety, for example video cassettes and digital video disks (DVDs).

Due to the mobility of automobiles, it is not practical to provide viewing opportunities comprising a hard-wired system, such as Cable television. In addition, even areas that are receptive to longer-term, yet non-hardwired, storage of vehicles do not offer Cable hook-ups, or other hard-wire viewing options. For example, many campgrounds offer electricity, water and other utility hook-ups for campers and other vehicles, but do not offer television viewing amenities.

Outdoor antennae designed to pick up UHF/VHF/FM signals are also not a viable alternative for the automobile television viewer. The limited channels available, plus the greater bulk and size preclude such systems from any practical automobile use. What is needed is a support system for a satellite dish antenna that can be mounted to a vehicle, provides a variety of viewing options, and that is stable and easy for the average person to install.

### SUMMARY OF THE INVENTION

Accordingly, it is an object of the present invention to provide alternative viewing capabilities for persons within, or in close proximity to, a vehicle such as an automobile.

It is also an object of the present invention to provide an easy and quick to install support system for a satellite dish television antenna that can be attached to a vehicle without damage or modification to the vehicle itself.

It is an additional object of the present invention to provide a support system for a satellite dish antenna that is stable and can withstand the rigors of travel inherent with attachment to the exterior of a vehicle.

It is a further object of the present invention to provide a support system for a satellite dish antenna that allows for variable height and angular positioning of the satellite dish.

The present invention comprises a satellite dish antenna support system comprising, a base support member, having square tube steel section capable of being fastened to a standard size square receiver hitch. The system also includes a pair of vertical support members, the first support member which is capable of telescopically receiving the second, extends upwardly from the base support member. The first support member attaches by any suitable means to an angle iron coupled to the base support member. The second support member is capable of telescoping in an upwardly direction and can be fixed at various heights. A satellite dish antenna fastens onto the upper region of the second support member via the standard satellite dish antenna LNB arm/antenna-back assembly.

One embodiment of the present invention comprises a satellite dish support system having a pair of vertical support members, telescopically related, including a cavity in the outer tube wherein a wingnut bolt may be introduced to provide a locking means sufficient to allow for upward telescoping of the other support member.

Another embodiment of the present invention comprises a satellite dish support system whereby a column, or multiple columns, of cavities or detents are located along the length of the inner tubular member. This embodiment allows for various alignments and lengths of the relative tubular members.

It should be noted that the same telescoping result could be obtained by situating the locking means and columns of cavities at the upper portion of the outer and inner vertical support members, respectively. In addition, the present invention could be constructed using hollow support members of either circular, or non-circular dimensions. For purposes of example, and not limitation, hollow square members could be related telescopically in a similar fashion. Also, a variety of nut and bolt combinations, and various locking pins, could be used as a locking means. Further, the support materials could be steel, plastic, or other suitable rigid material capable of stable antenna support.

Other objects and advantages of the present invention will be recognized when the following description is considered along with the drawings.

### BRIEF DESCRIPTION OF SEVERAL VIEWS OF THE DRAWING

FIG. 1 is a perspective view showing the satellite dish antenna support system mounted to a vehicle via the vehicle hitch receiver.

FIG. 2 is a side elevational view of the satellite dish antenna support system.

FIG. 3 is a side elevational view of the single columned receiving area embodiment of the satellite dish antenna support system.

FIG. 4 is a side elevational view of the multiple columned receiving area embodiment of the satellite dish antenna support system.

### DETAILED DESCRIPTION OF THE PREFERRED EMBODIMENT

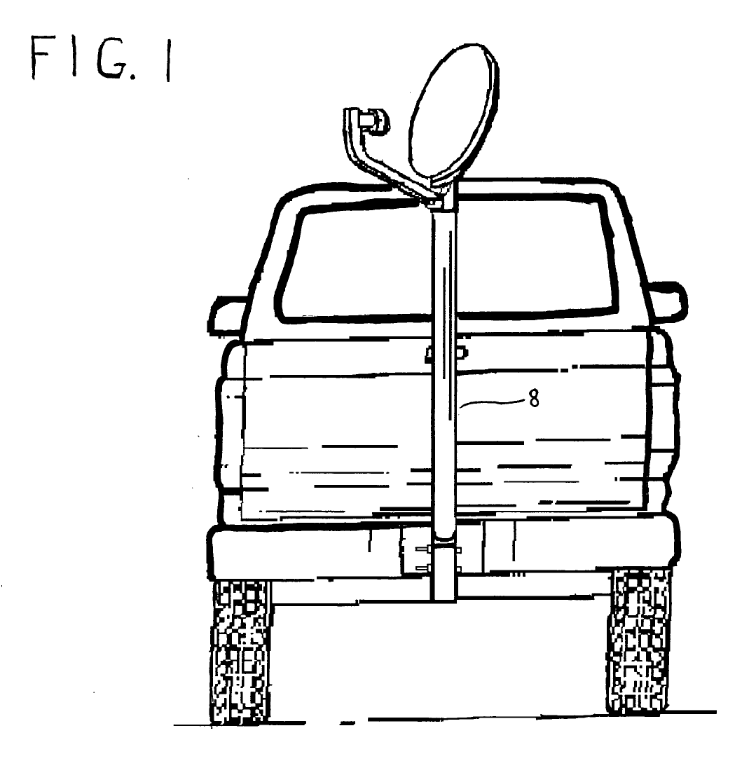

Referring to the drawings, FIG. 1 is a perspective illustration showing the satellite dish antenna support system 8, mounted to the trailer hitch receiver of a vehicle, with satellite dish antenna in place.

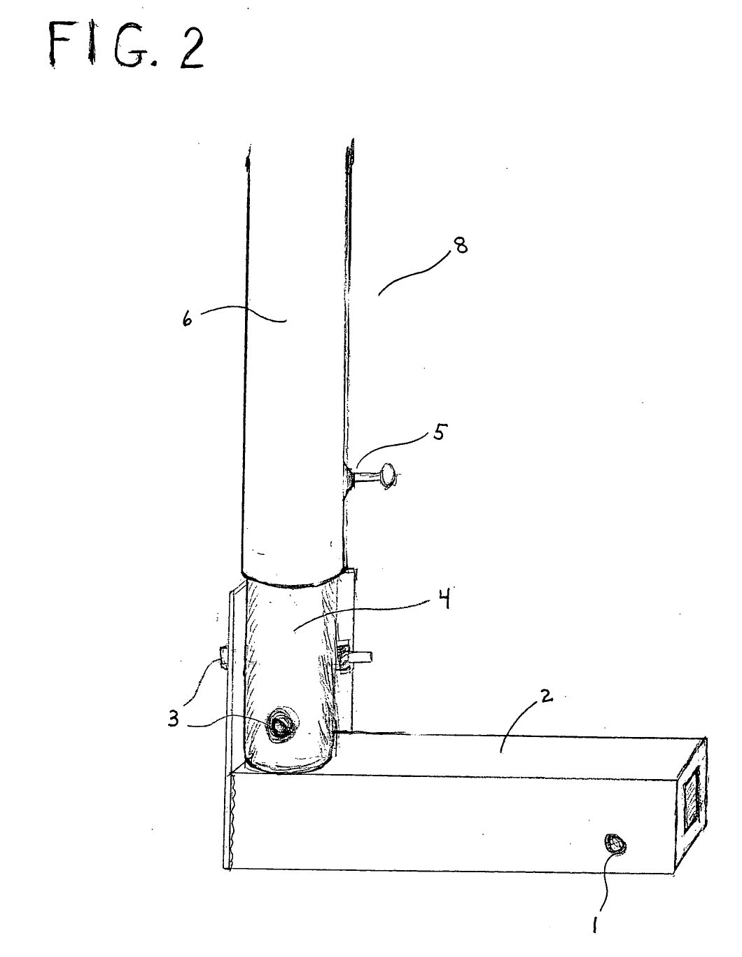

Referring to FIG. 2, a side elevational view is shown, depicting base support 2, capable of being received by a vehicle trailer hitch receiver and locked in place via any suitable means utilizing receptacle 1. The first support member 4 is shown affixed to an angle iron via bolt and nut configurations 3. Second support member 6 is shown in telescopic relation to support member 4 via locking pin 5.

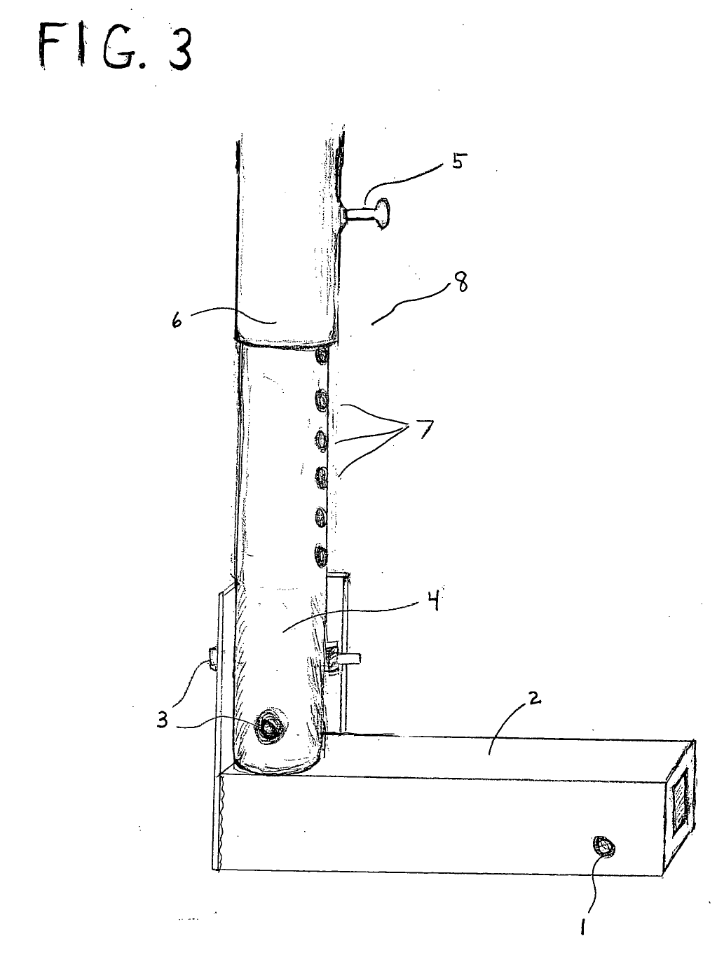

Referring to FIG. 3, the system 8 is provided with a plurality of inner receiving areas 7, to enable a variety of telescoping positions via locking means 5

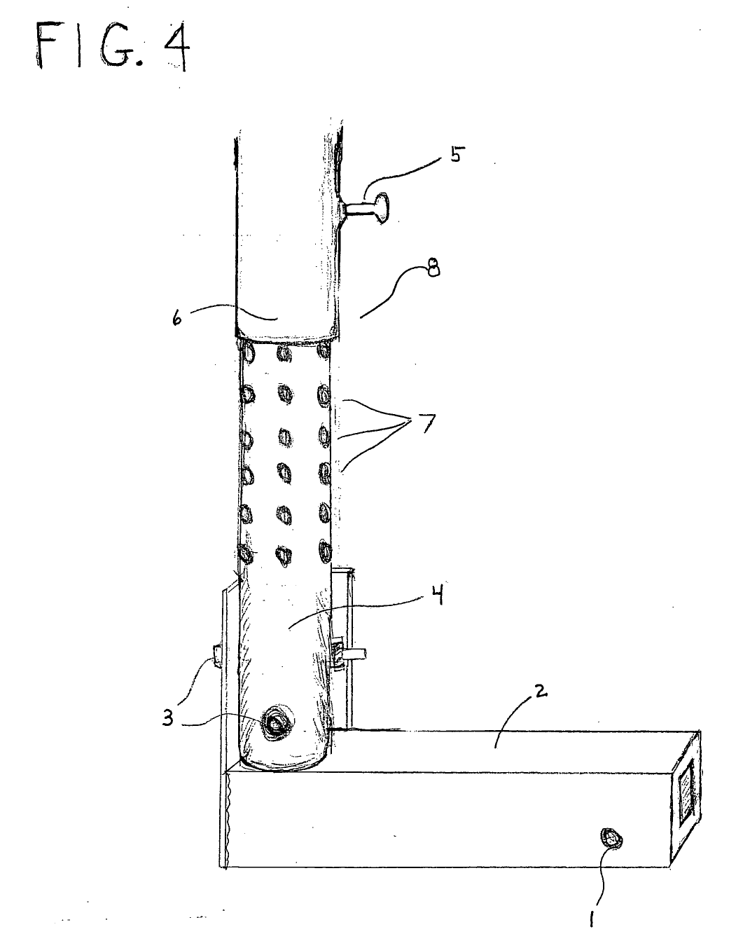

FIG. 4 shows an alternate embodiment of the satellite dish antenna system having multiple columns of the plurality of receiving areas 7, allowing for radial, as well as vertical relative positioning of support member 6.

1. A trailer hitch comprising:
a base support member; and
at least one vertical support member extending upwardly from said base support member.

2. A satellite dish antenna support system comprising:
a base support member; and
at least one vertical support member extending upwardly from said base support member.

3. The satellite dish antenna support system of claim 2, wherein said vertical support member is capable of engaging a satellite dish antenna.

4. A satellite dish antenna support system of claim 2 further comprising:
a plurality of vertical support members extending upwardly from said base support member, said vertical support members capable of engaging a satellite dish antenna.

5. The satellite dish antenna support system of claim 2, wherein said base support further comprises a support end and a hitch end, said hitch end having an outer perimeter slightly smaller than, and capable of being inserted into, a trailer hitch receiver.

6. The satellite dish antenna support system of claim 2 further comprising:
a square, tubular base support capable of being received by a standard trailer hitch receiver, said base support having a cavity on one side of suitable diameter to allow a locking pin to be inserted;
a length of angle iron extending upwardly approximately eight inches, having a front and a lateral side, said angle iron welded to said base support having said front and said lateral sides substantially flush with said base support; and
a vertical support member having first and second ends, said vertical support member extending upwardly from said base support, said first end bolted to said angle iron, and said second end capable of receiving a satellite dish antenna.

7. The satellite dish antenna support system of claim 6, wherein said vertical support member comprises first and second tubular members, said first tubular member telescopically receiving said second tubular member, said first tubular member having a plurality of cavities along the length thereof, said second tubular member having a single cavity designed to be selectively alignable with said plurality of cavities; and a locking pin sized to be inserted through said tubular members via said aligned cavities.

8. The satellite dish antenna support system of claim 6, wherein said trailer hitch receiver further comprises an elongated receiver tube having a hollow interior passage and walls of substantially uniform thickness and a cavity capable of receiving a locking pin; and a means for coupling said trailer hitch receiver to a vehicle.

9. A satellite dish antenna support system comprising
a base support member; and
a pair of vertical support members attached to said base support member, a first of said pair of vertical support members telescopically receiving a second of said pair of vertical support members; the second of said pair of vertical support members engaging a satellite dish antenna; and
a means for locking said pair of vertical support members in position.

10. The satellite dish antenna support system of claim 9 wherein said locking means is capable of selectively locking said first and said second vertical support members together in a plurality of relative positions to enable the length of said support bar to be selectively varied.

11. The satellite dish antenna support system of claim 9, wherein said locking means includes at least one outer receiving area in the second of said pair of vertical support members.

12. The satellite dish antenna support system of claim 11, wherein said locking means further comprises a removably attachable locking pin member with a diameter substantially similar to the diameter of said outer receiving area.

13. The satellite dish antenna support system of claim 11, wherein said locking means further comprises a plurality of inner receiving areas in the first of said pair of vertical support members, said plurality of inner receiving areas being selectively alignable with said outer receiving area.

14. The satellite dish antenna support system of claim 13, wherein said locking means is constructed to be received in aligned said inner and said outer receiving areas for locking said pair of vertical support members.

15. The satellite dish antenna support system of claim 13, wherein said plurality of inner receiving areas further comprise indentations.

16. The satellite dish antenna support system of claim 13, wherein said inner receiving areas are spaced a substantially equal distance from one another along the length of said first of said pair of vertical support members.

17. The satellite dish antenna support system of claim 13, wherein said inner receiving areas form at least one substantially straight line along the length of said first of said pair of vertical support members.

18. The satellite dish antenna support system of claim 13, wherein said inner receiving areas form a plurality of substantially straight lines along the length of said first of said pair of vertical support members.
